(19) United States
(12) Patent Application Publication
(10) Pub. No.: US 2025/0272449 A1
(43) Pub. Date: Aug. 28, 2025

(54) COMPUTER-IMPLEMENTED METHOD FOR GENERATING A MODIFICATION SUGGESTION AND CORRESPONDING DATA PROCESSING DEVICE

(71) Applicant: dSPACE GmbH, Paderborn (DE)

(72) Inventors: Eduard MILLER, Paderborn (DE); Markus KOCH, Paderborn (DE); Eugen SELBSTREICH, Paderborn (DE)

(73) Assignee: dSPACE GmbH, Paderborn (DE)

(21) Appl. No.: 19/061,384

(22) Filed: Feb. 24, 2025

(30) Foreign Application Priority Data
Feb. 26, 2024 (EP) 24159581

(51) Int. Cl. G06F 30/15

(52) U.S. Cl. CPC G06F 30/15

(57) ABSTRACT

A computer-implemented method for generating a modification suggestion for at least one simulation run of a simulation comprising a plurality of simulation runs. An error description of a simulation run of a first simulation is received, whereby the simulation run whose error description is received is based on a first parameter set comprising a plurality of parameter values. A not yet completed simulation runs of the first simulation or a second simulation with a parameter set that matches the first parameter set in at least one parameter value is identified. The modification suggestion for the identified simulation runs, taking into account the received error description, is generated. A data processing device to carry out the above method, a computer program product, and a corresponding computer-readable data carrier are also provided.

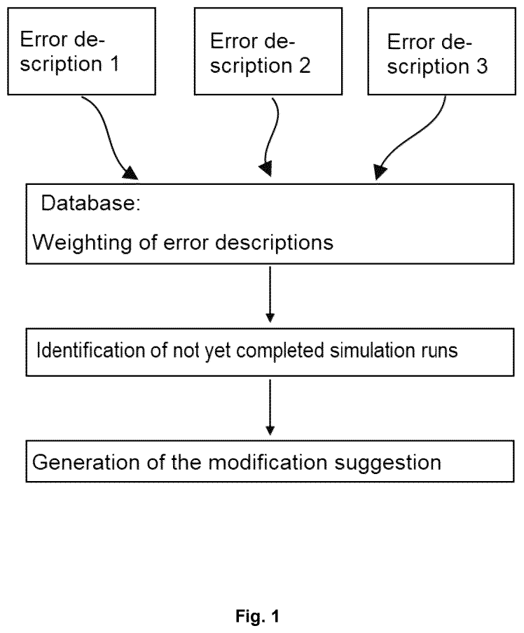

This nonprovisional application claims priority under 35 U.S.C. § 119 (a) to European Patent Application No. 24159581.8, which was filed on Feb. 26, 2024, and which is herein incorporated by reference.

### BACKGROUND OF THE INVENTION

### Field of the Invention

The invention relates to a computer-implemented method for generating a modification suggestion for at least one simulation run of a simulation comprising a plurality of simulation runs. The invention relates further to a data processing device comprising at least a processor to carry out the above method. The invention relates further to a computer program product comprising instructions which, when the program is executed by a computer, cause the computer to carry out the above method. Also, the invention relates further to a computer-readable data carrier on which the above computer program product is stored.

### Description of the Background Art

Driving assistance systems such as, e.g., an adaptive cruise control and/or functions for highly automated or autonomous driving can be verified or validated using various testing methods. For example, hardware in the form of the control unit or in the form of a control unit prototype can be used generally for functional tests of electronic control unit (ECU) software and the control software can be tested in real driving tests. However, in addition to the high costs and the very high expenditure of time, the lack of reproducibility is problematic with such tests due to the complex environmental conditions.

So-called hardware in the loop (HiL) tests are also available, in which the ECU is connected to a HiL simulator via inputs and outputs, whereby the HiL simulator replicates the real environment. The HiL simulator emulates the electrical signals from sensors and actuators, which are read by the ECU. For example, in a HiL test of an internal combustion engine, the signals from crankshaft and camshaft sensors are generated by an angular processing unit (APU) that is part of the HiL simulator hardware. On the basis of these signals, the ECU in turn generates by means of the control software the sensor and/or actuator control signals, which in turn lead to a change in the electrical signals in the HiL simulator. The route that would be driven as a test route in the real driving test and would thus generate different electrical signals for the control unit is mapped as a route model within the HiL simulation. However, in order to carry out a HiL test, the development of an ECU must already be relatively advanced, because the ECU is connected to the HiL simulator as hardware.

To enable earlier testing of the control software, for example, at a development stage when no hardware is yet available, hardware-independent software tests are required. Virtual control units, also known as V-ECUs, can be used for this purpose. A real control unit is emulated in a simulation scenario by means of a virtual control unit. In order to create virtual control units that are as close to reality as possible, a virtual control unit can be created based on the control software of the real control unit. Of course, some components of the control software of the real control unit must be adapted to the virtual environment of the simulation platform. This procedure usually has the goal of simulating a real control unit as well as possible.

However, moving virtual tests to earlier and earlier development phases leads to changed requirements, in which the best possible imitation of the behavior of a specific control unit is the focus, but in which a wide variety of applications are to be tested in a flexible and highly modular environment. This is usually done through reproducible, deterministic test drives with a virtual vehicle in a virtual environment. The vehicle, the environment, and the tests—therefore the traffic scenarios—can all be freely defined by the user. In this way, new algorithms for vehicle control in virtualized, autonomous vehicles can be tested, among other things.

A possible traffic scenario to be considered is, for example, a so-called cut-in scenario. The cut-in scenario describes a traffic situation in which a highly automated or autonomous vehicle—referred to below as an ego vehicle—drives in a predefined lane. Another vehicle cuts in from another lane into the lane of the ego vehicle at a certain distance from the ego vehicle and at a reduced speed compared to the ego vehicle.

In the traffic scenario, it is generally provided that the speed of the ego vehicle and the other vehicle is initially constant. However, because the speed of the ego vehicle is higher than that of the other vehicle, the ego vehicle must be slowed down in order to avoid a collision with the other vehicle.

The traffic scenario can be simulated with different parameter values, for example, different distances between the ego vehicle and the other vehicle when cutting in, or different speed differences between the ego vehicle and the other vehicle. In order to gain as much knowledge as possible from the simulation, many different simulation runs are therefore carried out in the possible parameter space. Complex traffic scenarios have many parameters and therefore a very large parameter space to be covered, so that over a hundred thousand simulation runs typically have to be carried out to cover the test space. Accordingly, such simulations are resource-intensive and/or time-intensive.

### SUMMARY OF THE INVENTION

It is therefore an object of the invention to simulate complex traffic scenarios in a resource-saving and cost-saving manner. For example, the object of the invention is to limit the value range of the parameters of the simulation.

According to an example of the invention, a computer-implemented method for generating a modification suggestion for at least one simulation run of a simulation comprising a plurality of simulation runs is thus provided, comprising the steps: receiving an error description of a simulation run of a first simulation, whereby the simulation run whose error description is received is based on a first parameter set comprising a number of parameter values; identifying not yet completed simulation runs of the first simulation or a second simulation with a parameter set that matches the first parameter set in at least one parameter value; and generating the modification suggestion for the identified simulation runs, taking into account the received error description.

An aspect of the invention therefore is that based on received error descriptions of already started simulation runs of the first simulation, modification suggestions are generated for not yet completed simulation runs of the first simulation or for not yet completed simulation runs of the second simulation, so that problems can be avoided in the not yet completed simulations. In other words, in the method, not yet completed simulation runs are thus automatically identified for which there is a high probability that these simulation runs are also faulty due to the at least partially matching parameter set for simulation runs whose error descriptions have been received. Accordingly, by taking into account the previous error descriptions, the generated modification suggestions can be implemented even before all simulation runs of the simulation are completed, which can save resources and costs.

A simulation can be understood as an implementation or realization of a simulation model. The simulation model represents an abstraction of the system to be simulated, for example, in terms of its structure, function, and/or its behavior. The execution of the simulation with specific parameter values is referred to as a simulation run. Once the simulation run has ended, the results can be interpreted and transferred to the system to be simulated.

Simulation therefore may mean setting a functional simulation model in motion and observing its behavior in certain situations. Depending on the complexity of the model, this process can be lengthy and computationally intensive—also because a single simulation run is not enough to gain knowledge. In other words, the simulation therefore has a large number of simulation runs, typically on the order of 100,000 simulation runs.

In the context of simulations, the parameter set can refer to those aspects of the simulation model that have been deliberately made to be flexible. By setting the parameters of the simulation model to specific values of the parameter set, the simulation model is shifted to a specific state whose behavior is then simulated. In other words, a pass of a simulation run requires the definition of specific values for the parameters of the parameter set.

During the simulation, the value for precisely one of the parameters in the parameter set can then be deliberately varied over a number of simulation runs, for example, so that the possibly different results of the simulation runs can be traced back to the influence of precisely this parameter. If a number of parameters are to be systematically and specifically varied and/or interactions between the parameters are to be understood, a large number of simulation runs are necessary, as already mentioned.

In addition to the targeted, specific variation of parameter values, another reason for the need for a plurality of simulation runs may be based on stochastic parameters. It can make sense to randomly define certain properties of a simulation- or the simulation model follows one rule or another with a certain probability in each simulation run. If a simulation contains such random elements, which are mapped using stochastic parameters, a single simulation run is of only limited significance. A number of repetitions are therefore absolutely necessary in order to estimate the behavior of the simulation model in a specific situation (with otherwise unchanged parameters).

For example, the plurality of simulation runs can have parameter values at least partially different from one another. In this way, the simulation runs cover the possible parameter space of the simulation.

If a simulation run is started, an error description may be generated when the simulation run is executed. Such error descriptions of the first simulation are received in the first step of the method. With regard to the error descriptions, these were generated, for example, because a technical problem—such as a missing file—has occurred or because a parameter has a value that is outside of predefined specifications. With regard to the second of these, an overtaking scenario of two vehicles requires, for example, that the vehicle behind at the start of the overtaking scenario has a higher speed than the vehicle which is in front at the start of the overtaking scenario and is to be overtaken. If the parameter value for the speed of the rear vehicle is so low, for example, that no overtaking scenario can take place at all, the value of the parameter is outside the predefined specifications.

In a further step of the method, those simulation runs of the first or second simulation can be identified which have not yet been completed and also have a parameter set in which at least one parameter has the same value as the simulation run whose error description was received. Not yet completed simulation runs are simulation runs that have not yet been started or simulation runs that have already been started but have not yet been completed.

In a further step of the method, the modification suggestion for the identified simulation runs can then be generated, taking into account the error description received.

The method can comprise the step of changing one or more as not yet completed simulation runs of the first or second simulation, taking into account the generated modification suggestion. Preferably, changes to the as not yet completed simulation runs of the first or second simulation are thus carried out automatically on the basis of the modification suggestion. In this way, costs can be saved and/or resources spared without interaction with a user.

The generated modification suggestion can comprise terminating not yet completed simulation runs, not executing simulation runs that have not yet been started, and/or adjusting the parameter values for simulation runs that have not yet been started. By terminating not yet completed simulation runs and not running simulation runs that have not yet been started, the number of simulation runs is reduced, which saves resources, time, and costs. Simulation runs which, based on the received error descriptions, are not expected to provide any additional knowledge and/or contain errors, are not even carried out. By adjusting the parameter values for simulation runs that have not yet been started, the simulation can be carried out with values that are within the predefined specifications, so that the knowledge gained from the simulations carried out increases.

The method can also comprise the additional step of generating an error description of a simulation run by starting, executing, and/or terminating a simulation run of the first simulation. The error descriptions received in the first step of the method may originate from precisely the first simulation for which the method for generating the modification suggestion is carried out.

Alternatively, it is provided that the received error descriptions originate from the first simulation, but the method for generating the modification suggestion is carried out for a different simulation, in other words, the second simulation. For example, the first simulation may have been started hours before the second simulation and still be running when the second simulation starts. Alternatively, the first simulation may have been started days before the second simulation and has already ended by the time the second simulation starts. Particularly in the case of large development projects in which a number of teams are working together, the present method enables the knowledge gained from the error descriptions generated in the first simulation to be used automatically to save resources and/or costs in other teams in relation to the second simulation.

As already mentioned, the error description may have been generated at different times during the simulation run. Generating an error description can—but need not—lead to the termination of the simulation run. If the error descriptions are generated due to a missing file, for example, or because a runtime error or hardware problem arises during the simulation run, it may be technically impossible to continue the simulation run. If, however, the error description occurs due to a parameter value outside a predefined specification, the simulation run can technically be terminated, but the knowledge gained from the terminated simulation run may be limited.

The step of receiving the error description of a simulation run of the first simulation can comprise a multiple receiving of the error descriptions generated when starting, executing, and/or terminating the plurality of simulation runs. In other words, therefore, not only is an error description preferably received, but the generated error descriptions are continuously received during the simulation, which comprises the plurality of simulation runs.

In this regard, the method can also comprise the step of storing the received error descriptions in a database. In other words, during the simulation in which the plurality of simulation runs are carried out, the database is successively filled over time with the received error descriptions.

Further, the method can comprise the step of weighting the received error description, and the modification suggestion is generated taking into account the weighting of the error description. By weighting the error descriptions, modification suggestions can be generated in a targeted manner. For example, if an error is serious, the corresponding error description can be weighted higher. Based on this, it may be provided preferably that the generated modification suggestion comprises terminating not yet completed simulation runs and not executing simulation runs that have not yet been started.

The step of weighting the received error description can comprise subdividing the received error descriptions into classes. Preferably, the received error descriptions are divided into (a) local errors that only affect a few of the simulation runs, for example, less than 1% of the simulation runs, (b) errors that affect a larger group, for example, 10% of the simulation runs, and (c) global errors that affect all simulation runs of the simulation.

The step of weighting the received error description can comprise taking into account a frequency of the error description over the plurality of simulation runs. As already mentioned, the received error descriptions are stored in a database. It is therefore preferably analyzed how often a specific error description is present in the database and how the frequency distribution of the error description changes over the time during which the simulation is carried out.

Furthermore, the step of weighting the received error description can be carried out by a neural network. For example, the weighting and/or the subdivision of the error descriptions into classes can be carried out by an artificial neural network and/or by means of algorithms based on machine learning.

In connection with the weighting, it may be provided that the step of weighting the received error description can be carried out taking into account user input data. This has the advantage that the user can manually intervene in the weighting and influence it.

The step of identifying a not yet completed simulation runs of the first simulation or the second simulation with a parameter set of the received error description that matches the first parameter set in at least one parameter value can comprise performing a cluster analysis. Preferably, a method for discovering similarity structures is therefore used to identify those simulation runs that have not yet been completed and for which it can be assumed, based on the error descriptions preferably available in the database, that they are also error-prone.

Further technical features and advantages are apparent to the person skilled in the art from the following description of a data processing device, a computer program product, and/or a computer-readable data carrier, as well as from the examples.

The object is also achieved by a data processing device comprising components, such as a computer having a memory, processor, display, etc. for carrying out the method described above. Preferably, the data processing device is a server-based device. This makes it possible for the user himself not to have to maintain any hardware resources for carrying out the method for generating the modification suggestion for at least one simulation run of the simulation comprising a plurality of simulation runs, but for the method to be made available to the user on a server.

The invention further relates to a computer program product comprising instructions which, when the program is executed by a computer, cause the computer to carry out the above method.

The invention also relates to a computer-readable data carrier on which the above computer program product is stored. For example, the instructions can be embedded on the computer-readable data carrier, and the instructions, when executed by a processor of the computer, cause the processor to carry out the method of generating the modification suggestion for at least one simulation run of the simulation comprising a plurality of simulation runs.

The technical advantages and effects of the data processing device, the computer program product, and the computer-readable data carrier are apparent to the person skilled in the art from the description of the method for generating the modification proposal, as well as from the examples described below.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawings which are given by way of illustration only, and thus, are not limitive of the present invention, and wherein the sole FIGURE schematically shows a flowchart of a method for generating a modification suggestion for at least one simulation run of a simulation comprising a plurality of simulation runs, according to an example of the invention.

### DETAILED DESCRIPTION

The FIGURE schematically shows a flowchart of a method for generating a modification suggestion for at least one simulation run of a simulation comprising a plurality of simulation runs, according to an example of the invention.

In a first step of the method, an error description of a simulation run of a first simulation is received, whereby the simulation run whose error description is received is based on a first parameter set comprising a number of parameter values. In the present example, as shown in the FIGURE, it is provided that error descriptions are repeatedly received and the received error descriptions are stored in a database.

In addition, it is provided in the example that the error descriptions received and stored in the database are weighted based on their frequency in the database.

In a further step of the method, not yet completed simulation runs of the first simulation or a second simulation are identified that have a parameter set that matches the first parameter set in at least one parameter value. In the present case, this is accomplished using a cluster analysis.

In addition, the method has the subsequent step of generating the modification suggestion for the identified simulation runs, taking into account the received error description. The generated modification suggestions also take into account the weighting of the error description.

The method is explained below using an example. Two simulations, each with 100,000 simulation runs, are started with a time delay. The first simulation, called Run_1, is started first. The first simulation, Run_1, via its configuration uses a specific test case, which is defined by a first parameter set with specific parameter values.

The second simulation, called Run_2, also uses the specific test case, therefore, has matching parameter values in its parameter set, and is started around 5 hours later than Run_1.

After 50,000 simulation runs of Run_1, an error occurs and a corresponding error description is generated. The error description is stored in the database. The error underlying the error description in Run_1 is so serious that all simulation runs of Run_1 that are executed with this particular test case are faulty and, as a result, not meaningful. The error description is accordingly classified as critical in the database.

Based on this classification of the error in the database, a modification suggestion, which includes terminating the as not yet completed simulation runs of Run_2, is generated for Run_2, in which the error has not yet occurred.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A computer-implemented method for generating a modification suggestion for at least one simulation run of a simulation comprising a plurality of simulation runs, the method comprising:
receiving an error description of a simulation run of a first simulation, whereby the simulation run whose error description is received is based on a first parameter set comprising a plurality of parameter values;
identifying not yet completed simulation runs of the first simulation or a second simulation with a parameter set that matches the first parameter set in at least one parameter value; and
generating the modification suggestion for the identified simulation runs, taking into account the received error description.

2. The method according to claim 1, wherein the method further comprises the step of changing one or more of the as not yet completed simulation runs of the first or second simulation, taking into account the generated modification suggestion.

3. The method according to claim 1, wherein the generated modification suggestion comprises a termination of not yet completed simulation runs, not carrying out simulation runs that have not yet been started, and/or adjusting the parameter values for simulation runs that have not yet been started.

4. The method according to claim 1, wherein the method comprises the additional step of generating an error description of a simulation run by starting, executing, and/or terminating a simulation run of the first simulation.

5. The method according to claim 1, wherein the step of receiving the error description of a simulation run of the first simulation comprises receiving a plurality of the error descriptions generated when starting, executing, and/or terminating the plurality of simulation runs.

6. The method according to claim 1, wherein the method comprises the step of storing the received error description in a database.

7. The method according to claim 1, wherein the method comprises the step of weighting the received error description, and the modification suggestion is generated taking into account the weighting of the error description.

8. The method according to claim 7, wherein the step of weighting the received error description comprises subdividing the received error descriptions into classes.

9. The method according to claim 7, wherein the step of weighting the received error description comprises taking into account a frequency of the error description over the plurality of simulation runs.

10. The method according to claim 7, wherein the step of weighting the received error description is carried out by a neural network.

11. The method according to claim 7, wherein the step of weighting the received error description is carried out taking into account user input data.

12. The method according to claim 1, wherein the step of identifying as not yet completed simulation runs of the first simulation or the second simulation with a parameter set of the received error description that matches the first parameter set in at least one parameter value comprises performing a cluster analysis.

13. A data-processing device to carrying out the method according to claim 1.

14. A computer program product comprising instructions which, when the program is executed by a computer, causes the computer to carry out the method according to claim 1.

15. A computer-readable data carrier on which the computer program product according to claim 14 is stored.
